(19) United States
(12) Patent Application Publication
(10) Pub. No.: US 2015/0011103 A1
(43) Pub. Date: Jan. 8, 2015

(54) ELECTRICAL CONNECTOR WITH IMPROVED SOLDER EFFECT

(71) Applicant: ALLTOP ELECTRONICS (SUZHOU) LTD., Taicang City (CN)

(72) Inventors: Wang-I YU, Jhonghe City (TW); Hung-Chi TAI, Jhonghe City (TW); Yi-Chang CHEN, Jhonghe City (TW)

(73) Assignee: ALLTOP ELECTRONICS (SUZHOU) LTD., Taicang City (CN)

(21) Appl. No.: 14/048,877

(22) Filed: Oct. 8, 2013

(30) Foreign Application Priority Data
Jul. 3, 2013 (CN) 201310276784.6

(51) Int. Cl. H01R 12/73

(52) U.S. Cl. CPC H01R 12/73
USPC 439/64; 439/65

(57) ABSTRACT

An electrical connector for being surface-mounted to a Printed Circuit Board (PCB) and electrically connected with a complementary connector, includes an insulative housing, a number of conductive contacts received in the insulative housing, and a fixing spacer. The insulative housing includes a front main portion defining a receiving space for accommodating the complementary connector. Each conductive contact includes a contacting portion partially exposed into the receiving space for electrically connecting with the complementary connector, and a termination portion extending along a direction parallel to the PCB. The fixing spacer is insert-molded with the conductive contacts.

### BACKGROUND OF THE INVENTION

1. Field of the Invention

The present invention relates to an electrical connector, more particularly to an electrical connector mounted on a Printed Circuit Board (PCB).

2. Description of Related Art

With the rapid development of the electronic technology, electrical connectors are widely used in electronic products for exchanging information or data etc. with peripheral devices. An electrical connector usually comprises an insulative housing, a plurality of contacts accommodated in the insulative housing, and an outer conductive shell enclosing the insulative housing. Solder feet of the contacts extend beyond the insulative housing for being soldered with a Printed Circuit Board (PCB). U.S. Pat. No. 7,303,438 disclosed a conventional electrical connector which is surface-mounted on a Printed Circuit Board (PCB) and mates with a complementary connector. The electrical connector comprises an insulative housing, a plurality of conductive contacts assembled in the insulative housing, and a conductive shell mounted on the PCB and arranged above a front section of the insulative housing.

To satisfy the requirements of stable signal transmission and high transmission efficiency of electric products, it needs to assure the high stability of the electrical connector. For a conventional electrical connector, contacts are usually assembled to an insulative housing along an up-to-down direction. However, such assembly means could generate problems in the conductive contacts, such as weak solder structures, true position and flatness are not easy to be controlled. Thus, faulty solder phenomenon will occur to influence the signal transmission.

Hence, it is necessary to improve the conventional electrical connector to address problems mentioned above.

### BRIEF SUMMARY OF THE INVENTION

Accordingly, an object of the present invention is to provide an electrical connector which can control structural strength, true position and flatness of solder structures of conductive contacts.

In order to achieve the above-mentioned object, an electrical connector adapted for being surface-mounted to a Printed Circuit Board (PCB) and electrically connected with a complementary connector, comprises an insulative housing, a plurality of conductive contacts received in the insulative housing, and a fixing spacer. The insulative housing comprises a front main portion defining a receiving space adapted for accommodating the complementary connector. Each conductive contact comprises a contacting portion partially exposed into the receiving space adapted for electrically connecting with the complementary connector, and a termination portion extending along a direction parallel to the PCB. The fixing spacer is insert-molded with the conductive contacts.

The foregoing has outlined rather broadly the features and technical advantages of the present invention in order that the detailed description of the invention that follows may be better understood. Additional features and advantages of the invention will be described hereinafter, which form the subject of the claims of the invention.

### BRIEF DESCRIPTION OF THE DRAWINGS

For a more complete understanding of the present invention, and the advantages thereof, reference is now made to the following descriptions taken in conjunction with the accompanying drawings, in which:

FIG. 1 is an assembled, perspective view of an electrical connector in accordance with the present invention;

FIG. 2 is a view similar to FIG. 1, but from a different aspect;

FIG. 3 is an exploded, perspective view of the electrical connector shown in FIG. 2;

FIG. 4 is a partially assembled, perspective view of an insulative housing, conductive contacts, and a fixing spacer;

FIG. 5 is a perspective view of an insulative housing shown in FIG. 2; and

FIG. 6 is a view similar to FIG. 5, but from a different aspect;

FIG. 7 is a perspective view of a first contact and a second contact shown in FIG. 2;

FIG. 8 is a perspective view of the fixing spacer shown in FIG. 2; and

FIG. 9 is a perspective view of a conductive shell shown in FIG. 2.

### DETAILED DESCRIPTION OF THE PREFERRED EMBODIMENTS

In the following description, numerous specific details are set forth to provide a thorough understanding of the present invention. However, it will be obvious to those skilled in the art that the present invention may be practiced without such specific details. In other instances, well-known circuits have been shown in block diagram form in order not to obscure the present invention in unnecessary detail. For the most part, details concerning timing considerations and the like have been omitted inasmuch as such details are not necessary to obtain a complete understanding of the present invention and are within the skills of persons of ordinary skill in the relevant art.

Reference will be made to the drawing figures to describe the present invention in detail, wherein depicted elements are not necessarily shown to scale and wherein like or similar elements are designated by same or similar reference numeral through the several views and same or similar terminology.

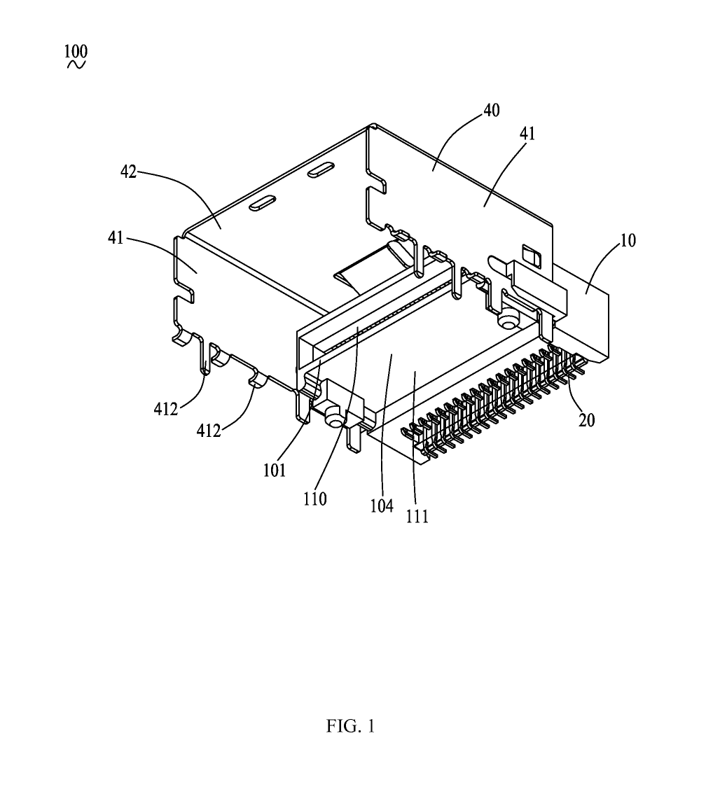

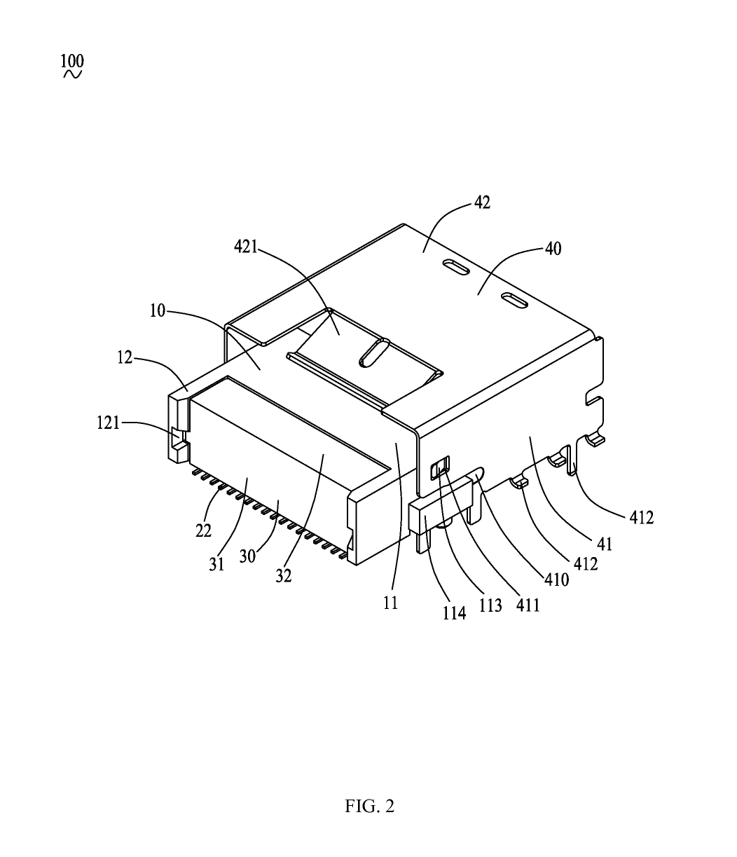

Please refer to FIGS. 1-3, an electrical connector 100 in accordance with the present invention is used to be assembled to a Printed Circuit Board (PCB, not shown) and electrically connects with a complementary connector (not shown). The electrical connector 100 comprises an insulative housing 10, a plurality of conductive contacts 20 assembled in the insulative housing 10, a fixing spacer 30 insert-molded with the conductive contacts 20, and a conductive shell 40 assembled to the insulative housing 10. In the preferred embodiment of the present invention, the electrical connector 100 is of right-angle mounting type, but in an alternative embodiment of the present invention, the electrical connector 100 also could be of vertical mounting type.

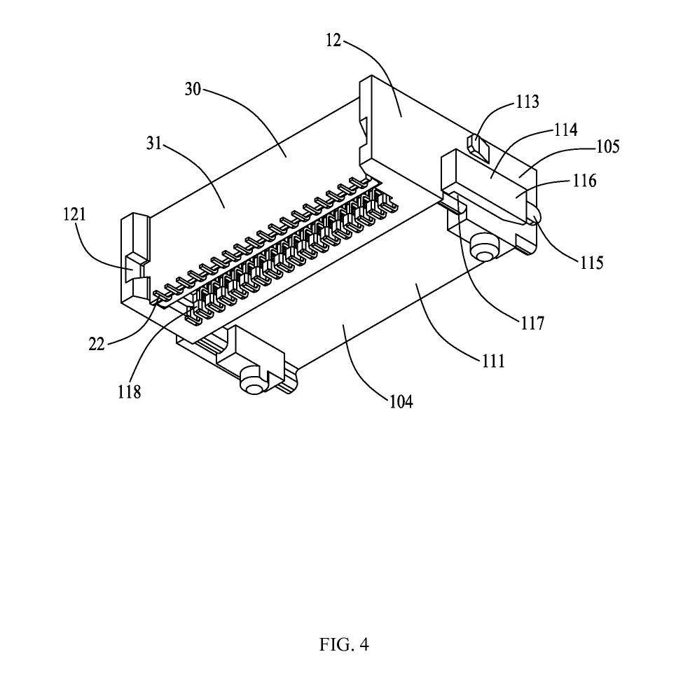

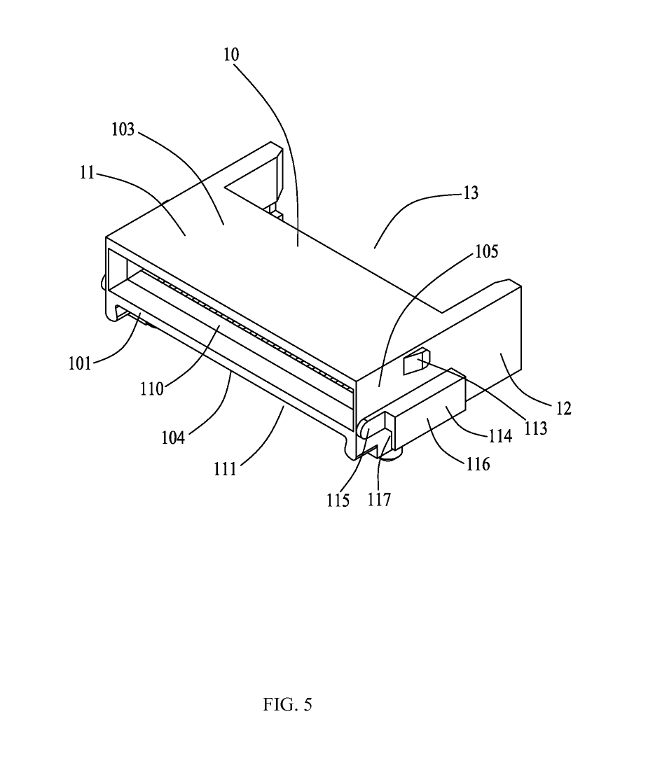

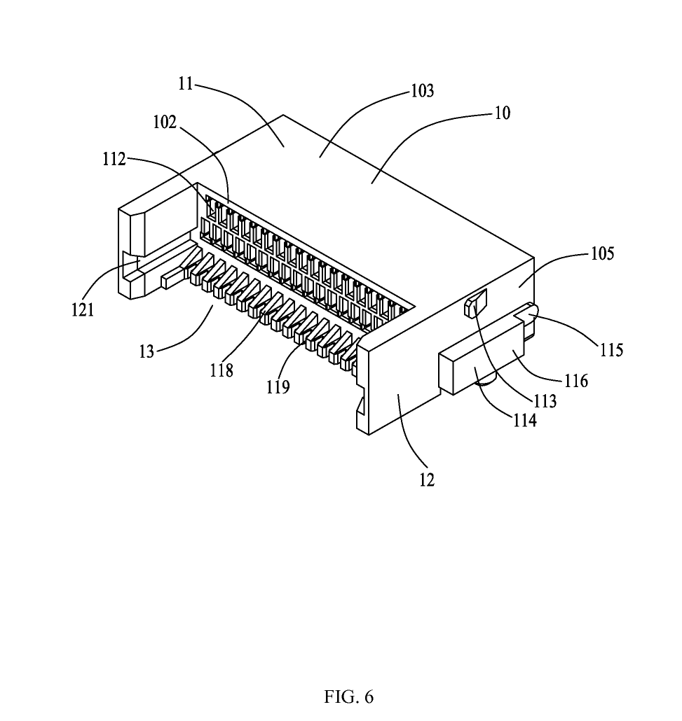

Please refer to FIGS. 1-6, the insulative housing 10 comprises a main portion 11 and a pair of stretch portions 12 extending from opposite lateral sides of the main portion 11. A U-shape accommodating space 13 is circumscribed by the pair of stretch portions 12 and the main portion 11. The main portion 11 defines a central receiving space 110 for receiving the complementary connector. The main portion 11 comprises a front wall 101, a rear wall 102 opposite to the front wall 101, a top wall 103, a bottom wall 104 opposite to the top wall 103, and a pair of left and right sidewalls 105 connecting with the front wall 101, the rear wall 102, the top wall 103, and the bottom wall 104. The receiving space 110 is circumscribed by the top wall 101, the rear wall 102, the top wall 103, the bottom wall 104, and the pair of sidewalls 105. A receiving channel 111 is circumscribed by the rear wall 102, the bottom wall 104 and the pair of sidewalls 105. In the preferred embodiment of the present invention, the cross sections of the receiving space 110 and the receiving channel 111 are rectangular, and both the receiving space 110 and the receiving channel 111 penetrate the front wall 101. Two rows of contact-receiving slots 112 are respectively defined in both the top wall 103, and the bottom wall 104 and penetrate the rear wall 102 for the convenient assembly of the conductive contacts 20 into the contact-receiving slots 112.

Each stretch portion 12 extends rearward from a junction area between the sidewall 105 and rear wall 102. A mounting slot 121 is defined in the inner side of the stretch portion 12 and extends along a front-to-back direction. Each mounting slot 121 opens toward the other mounting slot 121 and communicates with the accommodating space 13. Each sidewall 105 is formed with a wedged block 113 near to the top wall 103, and a restriction section 114 located below the wedged block 113 and near to the bottom wall 104. The restriction section 114 comprises a flat first stretching section 115 extending outwardly from the sidewall 105, and an L-shape second stretching section 116 extending rearward from the first stretching section 115 and extending outwardly from the sidewall 115 at the same time. Thus, a slit 117 is defined by the second stretching section 116 and the sidewall 105. A plurality of partition blocks 118 extend rearward from a lower section of the rear wall 102 and near to the bottom wall 104 to be exposed into the accommodating space 13. A plurality of positioning slots 119 are defined by every two adjacent partition blocks 118.

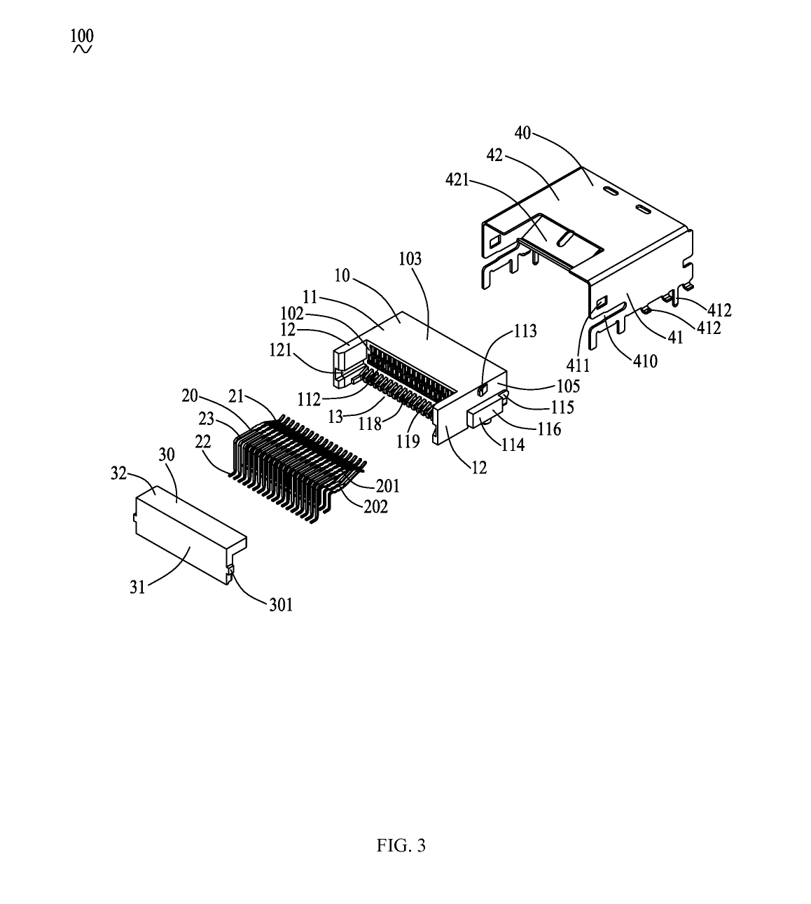

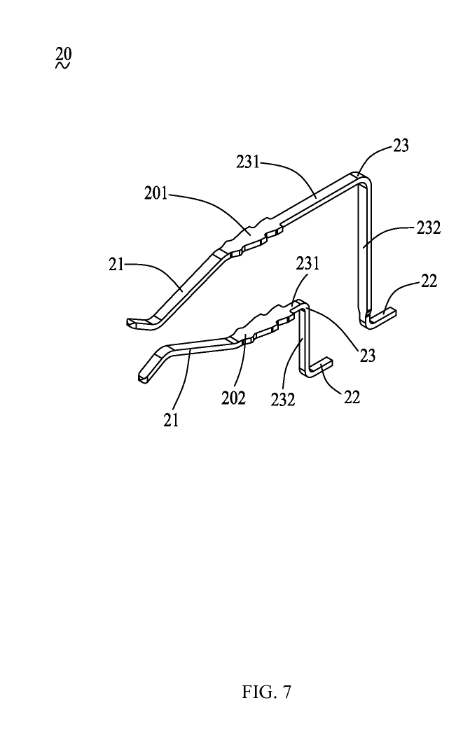

Please refer to FIGS. 3-7, each conductive contact 20 comprises a contacting portion 21, a termination portion 22 in the form of a flat surface-mounting solder foot, and an L-shape intermediate portion 23 connecting the contacting portion 21 with the termination portion 22. The contacting portion 21 is inserted into the insulative housing 10 from the accommodating space 13 into the corresponding contact-receiving slot 112 and partially exposed into the receiving space 110 for forming electrical connection with the complementary connector inserted into the receiving space 110. The termination portion 22 extends along a direction parallel to the PCB and is soldered to the PCB by surface-mounting way. The intermediate portion 23 comprises a horizontal first intermediate section 231 connecting with the contacting portion 21, and a vertical second intermediate section 232 bending downwardly from the first intermediate section 231 and connecting with the termination portion 22. A plurality of barbs (not labeled) is formed on opposite lateral edges of the first intermediate section 231 for interferentially engaging with the contact-receiving slot 112. The conductive contacts 2 comprise a plurality of first contacts 201 arranged in an upper row, and a plurality of second contacts 202 arranged in a lower row, that is below the first contacts 201. Thus, the contacting portions 21 of the first contacts 201 are arranged above the contacting portions 21 of the second contacts 202. The termination portions 22 of the first contacts 201 are arranged behind the termination portions 22 of the second contacts 202. In the preferred embodiment of the present invention, the termination portions 22 of the first and second contacts 201, 202 extend along the same direction. However, in an alternative embodiment, the termination portions 22 of the first and second contacts 201, 202 can extend along opposite directions. The length of the second intermediate section 232 of the first contact 201 is longer than that of the second intermediate section 232 of the second contact 202.

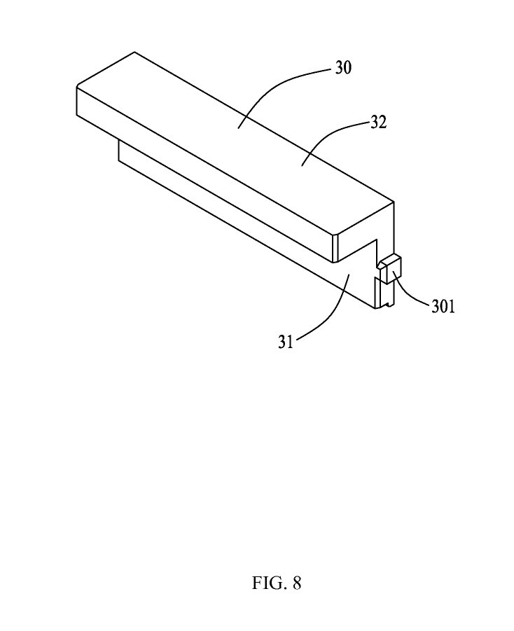

Please refer to FIGS. 3-8, the fixing spacer 30 is of L-shape, and comprises a vertical first section 31 and a horizontal second section 32 extending forwardly from a top edge of the first section 31. A pair of cooperating blocks 301 is formed on opposite lateral edges of the first section 31 for sliding along the mounting slots 121 to guide the fixing spacer 30 assembled to the insulative housing 10 and fill the accommodating space 13. The fixing spacer 30 is insert-molded with the first contacts 201. The first section 31 of the fixing spacer 30 fully wraps the second intermediate section 232 of the first contacts 201, while the second section 32 at least partially wraps the first intermediate section 231 of the first contacts 201. Thus, the structural strength of solder structures of the first contacts 201 could be enhanced. Further, the true position and flatness of the termination portions 22 of the first contacts 201 can be controlled well, thus, preventing faulty solder between the termination portions 22 of the first contacts 201 and the PCB. The second intermediate sections 232 of the second contacts 202 are respectively positioned in the positioning slots 119, thus, the true position and flatness of the termination portions 22 of the second contacts 202 could be assured, and the faulty solder between the termination portions 22 of the second contacts 20 and the PCB could be avoided.

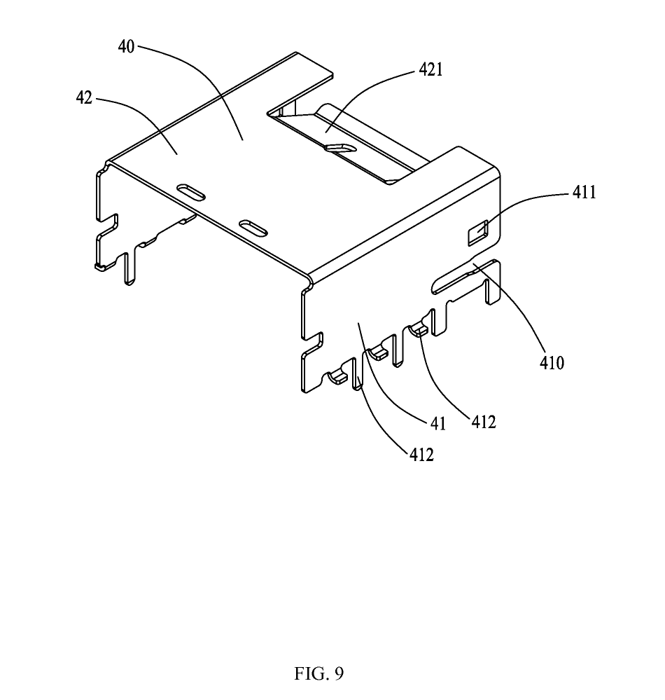

Please refer to FIG. 9, and in conjunction with FIGS. 3-6, the conductive shell 40 comprises a pair of lateral walls 41, and an upper wall 42 connecting the pair of lateral walls 41. The height of the lateral wall 41 of the conductive shell 40 is higher than that of the insulative housing 10. The upper wall 42 is disposed with an elastic section 421 extending from a rear edge of the upper wall 42 toward the top wall 103 of the insulative housing 10. Each lateral wall 41 defines a rectangular latching hole 411 to latch with the wedged block 113 on the sidewall 105 of the insulative housing 10, and a long and narrow notch 410 extending forwardly from a rear edge of the lateral wall 41 to cooperate with the restriction section 114 of the insulative housing 10, thus the conductive shell 40 could be assembled to the insulative housing 10. A plurality of mounting feet 412 of surface-mounting type and through-hole type extends downward from a bottom edge of each lateral wall 41 for being mounted to the PCB.

It is to be understood, however, that even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed. For example, the tongue portion is extended in its length or is arranged on a reverse side thereof opposite to the supporting side with other contacts but still holding the contacts with an arrangement indicated by the broad general meaning of the terms in which the appended claims are expressed.

We claim:

1. An electrical connector adapted for being surface-mounted to a Printed Circuit Board (PCB) and electrically connected with a complementary connector, comprising:
an insulative housing comprising a front main portion defining a receiving space adapted for accommodating said complementary connector;
a plurality of conductive contacts received in the insulative housing, each conductive contact comprising a contacting portion partially exposed into the receiving space adapted for electrically connecting with the complementary connector, and a termination portion extending along a direction parallel to the PCB; and
a fixing spacer insert-molded with the conductive contacts.

2. The electrical connector as claimed in claim 1, wherein the insulative housing comprises a pair of stretch portions extending rearward from opposite lateral ends of the main portion, and an accommodating space is circumscribed by the main portion and the pair of stretch portions.

3. The electrical connector as claimed in claim 2, wherein each stretch portion defines a mounting slot on inner side thereof to communicate with the accommodating space, and wherein the fixing spacer is received in the accommodating space and forms a pair of cooperating blocks on opposite sides thereof to cooperate with the mounting slots respectively.

4. The electrical connector as claimed in claim 1, wherein each conductive contact further comprises an intermediate portion connecting the contacting portion with the termination portion, and wherein the intermediate portion comprises a horizontal first intermediate section connecting with the contacting portion, and a vertical second intermediate section connecting with the termination portion.

5. The electrical connector as claimed in claim 4, wherein the conductive contacts comprise a plurality of first contacts arranged in an upper row, and a plurality of second contacts arranged in a lower row, and wherein the fixing spacer is insert-molded with the first contacts.

6. The electrical connector as claimed in claim 5, wherein the contacting portions of the first contacts are located above the contacting portions of the second contacts, and the termination portions of the first contacts are located behind the termination portions of the second contacts.

7. The electrical connector as claimed in claim 6, wherein the second intermediate sections of the first contacts are longer than the second intermediate sections of the second contacts, and wherein the fixing spacer is insert-molded with the intermediate portions of the first contacts.

8. The electrical connector as claimed in claim 5, wherein the fixing spacer comprises a vertical first section and a horizontal second section bending forwardly from the first section, and wherein the first section of the fixing spacer wraps the second intermediate sections of the intermediate portions of the first contacts, and the second section of the fixing spacer partially wraps the first intermediate sections of the intermediate portions of the first contacts.

9. The electrical connector as claimed in claim 4, wherein the insulative housing forms a plurality of partition blocks extending rearward from a lower section of a rear wall of the main portion, and wherein a plurality of positioning slots are formed between adjacent two partition blocks, and the second intermediate sections of the intermediate portions of the second contacts are respectively positioned in the positioning slots.

10. The electrical connector as claimed in claim 1, wherein the insulative housing defines two rows of contact-receiving slots in a top wall and an opposite lower wall, and wherein the contact-receiving slots communicate with the receiving space, and the contacting portions of the first and second contacts are respectively received in the contact-receiving slots and partially exposed into the receiving space.

11. The electrical connector as claimed in claim 1, further comprising a conductive shell assembled to the insulative housing and comprising a pair of lateral walls and an upper wall connecting with the pair of lateral walls, and wherein the height of the pair of lateral walls is higher than that of the insulative housing.

12. The electrical connector as claimed in claim 11, wherein the upper wall of the conductive shell forms an elastic section extending toward a top wall of the insulative housing from a rear edge of the upper wall.

13. The electrical connector as claimed in claim 11, wherein each lateral wall defines a long notch extending forwardly from a rear edge thereof, and the insulative housing forms a corresponding restriction section on a sidewall thereof to cooperate with the notch.
